(19) United States
(12) Patent Application Publication
(10) Pub. No.: US 2014/0366127 A1
(43) Pub. Date: Dec. 11, 2014

(54) TOUCHSCREEN SECURITY USER INPUT INTERFACE

(71) Applicant: International Business Machines Corporation, Armonk, NY (US)

(72) Inventors: Lisa Seacat DeLuca, Baltimore, MD (US); Dana L. Price, Cary, NC (US)

(21) Appl. No.: 13/911,204

(22) Filed: Jun. 6, 2013

(51) Int. Cl. G06F 21/36

(52) U.S. Cl. CPC G06F 21/36
USPC 726/19

(57) ABSTRACT

A touchscreen security interface for guiding a user in entering a “pattern-based password” (for example, a password based on one or more gestures of a fingertip or stylus). The touchscreen security interface can alternatively be displayed at multiple angular orientations which can make the password entry process more secure with respect to phenomena like grease attacks and shoulder surfing. The touchscreen security device may take the form of a rotatable keypad, rotatable between four different angular orientations occurring at 90 degree angular intervals.

### FIELD OF THE INVENTION

The present invention relates generally to the field of touchscreen data entry, and more particularly to touchscreen security-related data entry (for example, password entry).

### BACKGROUND OF THE INVENTION

One known form of password entry is entry of the password by a user's fingertip(s) touching a touchscreen (for example, a touchscreen built into a smart phone) at predetermined locations corresponding to the letters, numbers, symbols, etc. of the chosen password. More specifically, it is known to: (i) have a user tap a touchscreen keyboard with discrete “touches” to enter a password (herein called typing-style password entry); and/or (ii) have a user trace a pattern with her fingertip (herein called pattern-based password entry), such as a pre-determined pattern, or “gesture,” traced over a matrix of dots. Many, if not all, touch-sensitive keypads and password entry mechanisms have screen elements that are in static locations that are not changed from instance of password entry to the next. Password entry can result in a smudge on the touchscreen that mimics the password for entry. If a password requires both typing-style and pattern-based (or gestural) user input then it is herein to be considered as a pattern-based password.

U.S. Pat. No. 6,925,169 (“169 Habu”) discloses as follows: “Then the screen monitor displays the entry keys circularly in order. When the user touches the “Scramble” button on the screen monitor, the CPU generates a random number and makes the keys on the screen rotate by this random number of key units. And the CPU stores the number of key units shifted by the rotation, and displays the entry keys again . . . . The user enters his PIN by touching the entry keys displayed on the touch screen monitor. Then the CPU recognizes which keys were selected by matching the locations the user touched and the displayed information of the keys. When the user pushes the “Enter” button 68 after completing the PIN entry, the CPU finishes the PIN entry processing . . . . As mentioned above, the user can rotate the entry keys before or after entering his PIN. By changing the location of the keys by the rotation, it is possible to protect the PIN from theft by observation of the finger movement. Since the keys are still circularly arranged in order, not random, it is easy for users including visually handicapped people to touch the keys even after rotating this device. Accordingly, this invention provides a user with an information entry device that prevents the PIN theft and key-mistouching.” (Reference numbers omitted in the quotation of 169 Habu to prevent confusion).

### SUMMARY

According to an aspect of the present invention, a method includes the following actions (not necessarily in the following order): (i) selecting a selected security interface display from a plurality of possible security interface displays; and (ii) sending the selected security interface display data for making the selected security interface display. Each security interface display of the plurality of possible security interface displays includes a pattern entry area and an orientation indication. Each orientation indication is a visual indication of correct pattern-based password entry angular orientation. At least two of the security interface displays of the plurality of possible security interface displays have respective orientation indications that respectively indicate different correct pattern-based password angular orientations. At least the sending step is performed by computer software running on computer hardware.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a schematic view of a computer sub-system (that is, a part of the computer system that itself includes a processing device) portion of the first embodiment computer system;

FIG. 3A is a flowchart showing a process performed, at least in part, by the first embodiment computer system;

FIG. 3B is a schematic view of a portion of the first embodiment computer system that includes software for performing at least a portion of the process of FIG. 3A;

FIG. 4A is a first screenshot generated by the first embodiment computer system;

FIG. 4B is a second screenshot generated by the first embodiment computer system;

FIG. 5A is a first screenshot generated by a second embodiment of a computer system according to the present invention;

FIG. 5B is a second screenshot generated by the second embodiment computer system;

FIG. 5C is a third screenshot generated by a second embodiment of a computer system according to the present invention;

FIG. 5D is a fourth screenshot generated by the second embodiment computer system;

FIG. 5E is a fifth screenshot generated by the second embodiment computer system;

FIG. 6A is a first screenshot generated by a third embodiment of a computer system according to the present invention;

FIG. 6B is a second screenshot generated by the third embodiment computer system;

FIG. 6C is a third screenshot generated by the third embodiment computer system;

FIG. 7A is a first screenshot generated by a fourth embodiment of a computer system according to the present invention; and

FIG. 7B is a second screenshot generated by the fourth embodiment computer system.

### DETAILED DESCRIPTION

This DETAILED DESCRIPTION section will be divided into the following sub-sections: (i) The Hardware and Software Environment; (ii) Operation of Embodiment(s) of the Present Invention; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

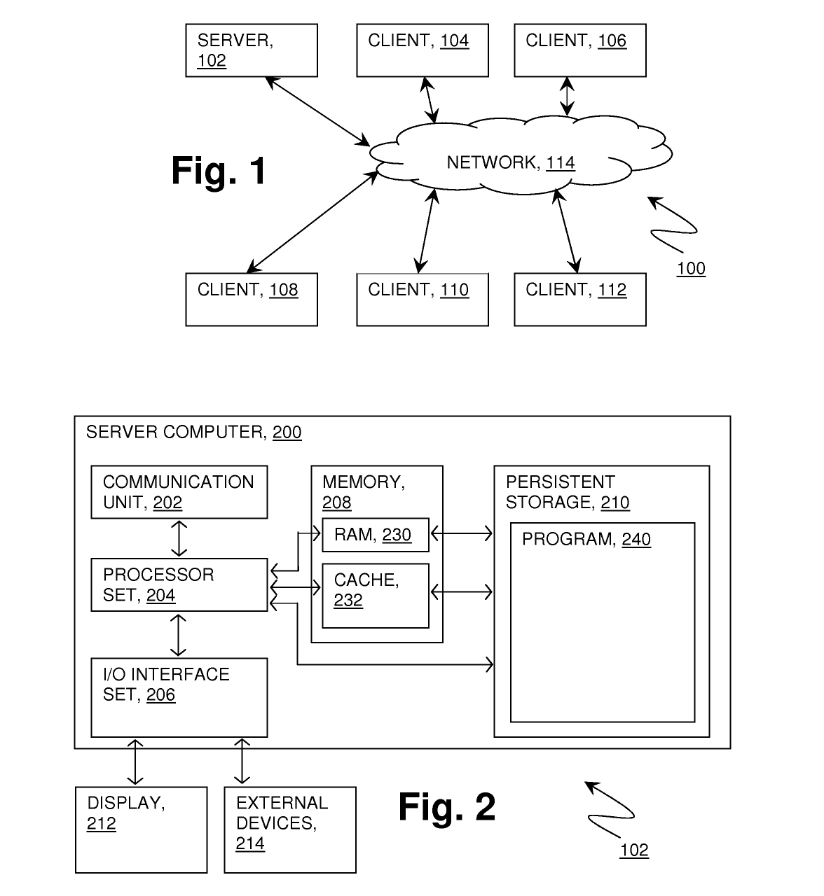

An embodiment of a possible hardware and software environment for software and/or methods according to the present invention will now be described in detail with reference to the Figures. FIGS. 1 and 2 collectively make up a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) unit 206; memory device 208; persistent storage device 210; display device 212; external device set 214; random access memory (RAM) devices 230; cache memory device 232; and program 240.

As shown in FIG. 2, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 is a representative piece of software, and is a collection of machine readable instructions and data that is used to create, manage and control certain software functions that will be discussed in detail, below, in the Operation Of the Embodiment(s) sub-section of this DETAILED DESCRIPTION section.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is in many respects representative of the various software of the present invention and is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Operation of Embodiment(s) of the Present Invention

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

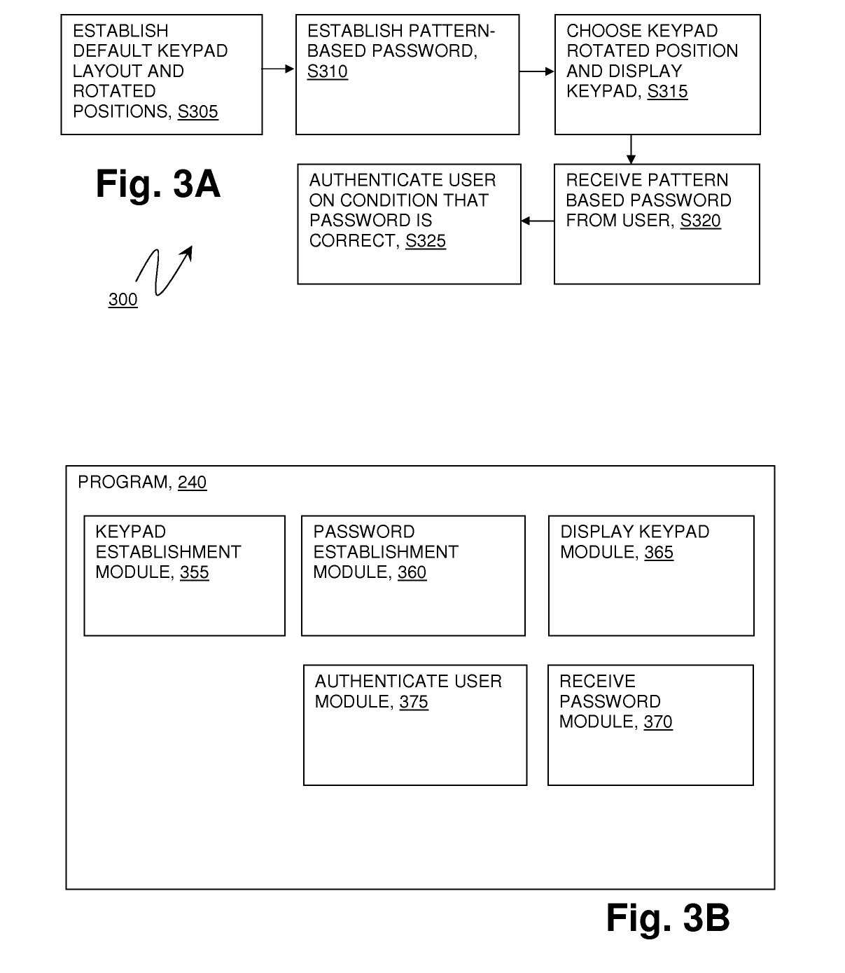

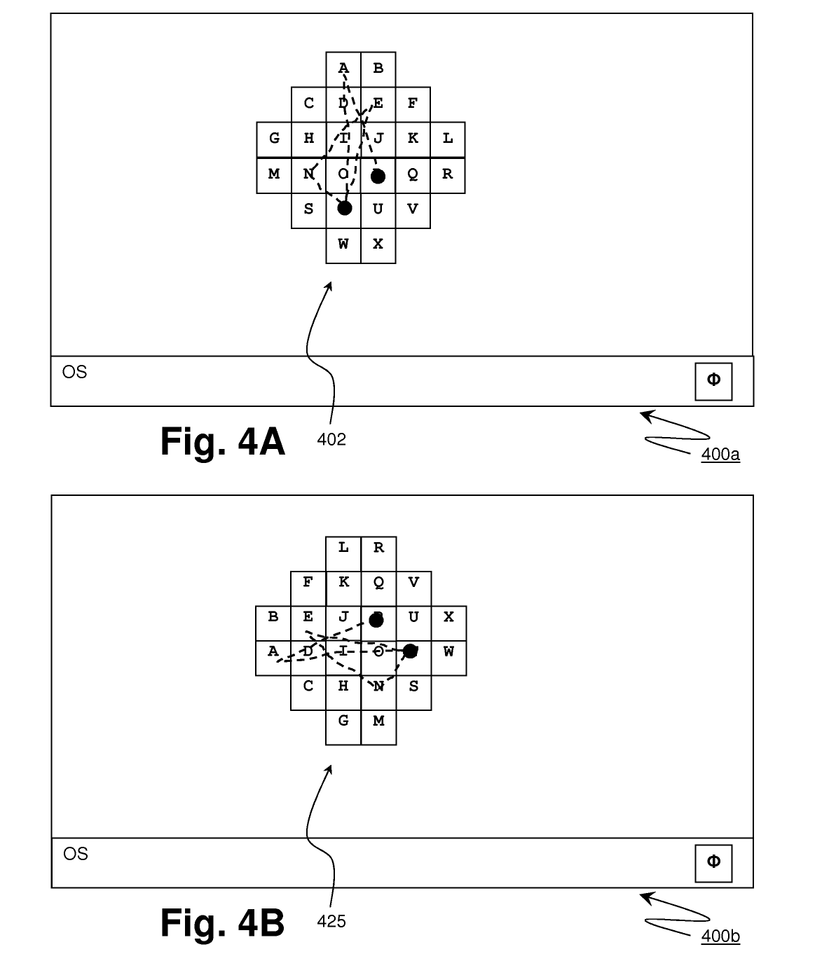

FIG. 3A shows a flow chart 300 depicting a method according to the present invention. FIG. 3B shows program 240 for performing at least some of the method steps of flow chart 300. This method and associated software will now be discussed, over the course of the following paragraphs, with extensive reference to FIG. 3A (for the method step blocks) and FIG. 3B (for the software blocks). In this embodiment, program 240 (see FIGS. 2 and 4) is located on a server computer, and serves multiple client sub-systems through network 114 (see FIG. 1). Alternatively, program 240 may be stored and run locally with respect to the touchscreen user interface that it helps manage and control. For example, program 240 may be stored and run on a smart phone, rather than a remote server computer.

Processing begins at step S305 where keypad establishment module 355 defines a keypad, including a keypad default position, and a plurality of positions where (at least a portion of) the keypad is rotated. In this embodiment, the rotated positions are determined by rotating the keypad at regular intervals about the center point (or center key) of the keypad. Alternatively, the keypad may be rotated about other points, so long as the resultant asymmetry from using an off-center axis of rotation is not too disruptive, or distracting, to users who are to be using the keypad. FIG. 4A shows an example of display 400a including pattern-based password entry keypad 402 in its default position. FIG. 4B shows an example of display 400b including pattern-based password entry keypad 425 in one of its three rotated positions.

Processing proceeds to step S310 where password establishment module 360 establishes a pattern-based password for the user. In this embodiment, the pattern is the pattern formed by tracing the letters P, A, T, E, N, T on the keypad in order (or reverse order). In this embodiment, the pattern can be made by a single continuous gesture (for example, by fingertip, by stylus). This single-gesture pattern-based password is shown by dashed lines in FIGS. 4A and 4B, respectively. Alternatively, a pattern-based password may require multiple gestures on the touchscreen. However, a pattern-based password, as that term is hereby defined, does not include multiple discrete hits or taps because that would be a typing-style password, which is considered as a fundamentally different and non-analogous kind of password with respect to a pattern-based password. In this document, pattern-based and typing-style passwords are generically referred to as simply “passwords,” in order to prevent confusion between the two different types.

Processing proceeds to step S315 where display keypad module 365 displays a keypad on the touchscreen of the user's device. To explain more fully, a user at one of the client sub-systems 104, 106, 108, 110, 112 (see FIG. 1) wants to be authenticated into an application that uses the security touchscreen user interface of this embodiment of the present invention. Display keypad module 365 receives a request through network 114 (see FIG. 1), and: (i) chooses which keypad to display (that is default position or one of the rotated positions); and (ii) sends data corresponding to the chosen display to the appropriate client device so that the user of the client sub-system will have a visual display to guide her entry of the password pattern in a correct orientation. As mentioned above, keypad displays, resulting from performance of step S315 are shown, respectively, in FIGS. 4A and 4B.

Processing proceeds to step S320 where receive password module 370 receives (through network 114, see, FIG. 1) a password pattern entered by the user. Two examples of a user's entered pattern are shown by the dashed lines of FIGS. 4A and 4B respectively. Because the keypad is rotated by 90 degrees as between the default position of FIG. 4A and the rotated position of FIG. 4B, the user traces the same pattern (albeit rotated by 90 degrees) for the authentication instance of FIG. 4A and the later authentication instance of FIG. 4B. As discussed below, if the user rotates the touchscreen, or tilts her head to a sideways position, then the password patterns are the same in both shape and angular orientation (relative to the user's eyeballs). This can make it easier for the user to enter the pattern-based password, even when the keypad is presented in new and unfamiliar rotated positions.

Processing proceeds to step S325 where authenticate user module 375 decides whether the user can be authenticated based upon the pattern entered at step S320. This evaluation will be made based upon both the shape and orientation of the pattern, where the chosen keypad position (previously chosen at step S315) will determine the correct angular orientation, or correct range of permissible angular orientations.

### III. Further Comments and/or Embodiments

The present invention recognizes that conventional touchscreen entry is potentially problematic because it may allow an onlooker to guess passwords and PINs (personal identification number) by observing the movement of the keypad user's hands. Another potential problem with touchscreen password entry (for example, pattern-based password entry) is the tracing of the predetermined pattern, by a fingertip, can leave a visible grease pattern on the screen of the device. If the device were to fall into the wrong hands, the pattern-based password could be determined by unauthorized parties by observing the smudge pattern that the user's finger has left on the screen.

Some embodiments of the present invention aim to solve these problems by allowing soft keypads to be randomly rotated, making it harder for onlookers to guess passwords and PINs that can be recognized through hand positions, and user-applied patterns that can be recognized through grease residue observation. This random rotation is to be distinguished from mobile screen rotations. Mobile devices, such as phones and touch tablet computers will rotate horizontally or vertically when the user moves the device, in hopes of showing the display in the orientation in which the user is holding the device. However, this does not solve the grease stain problem from smudge attacks because when the screen rotates, then the pattern location also rotates. In some embodiments of the present invention, the screen rotation can be used in combination with the passcode pad area also being rotated. Some embodiments of the present invention increase character entry security through keypad rotation mechanisms.

In some embodiments of the present invention, a user goes to enter her password (typing-style or pattern based) for entry into the device or application. The input keyboard, or other pattern-based user interface, is displayed to the user on the touchscreen.

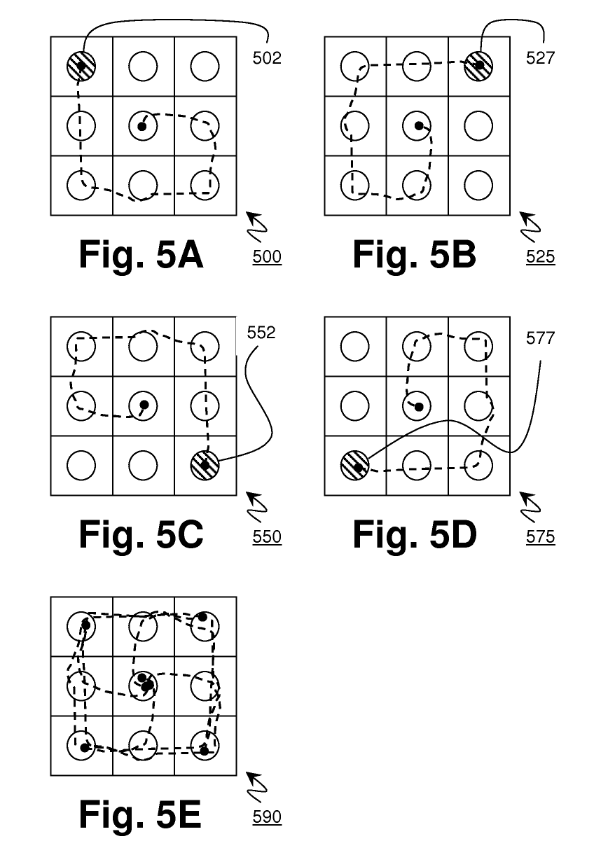

FIG. 5A shows touchscreen display 500 including starting point indication 502. The dashed line shows a user's fingertip path tracing out a pattern-based password in its default orientation.

FIG. 5B shows touchscreen display 525 including starting point indication 527. Note that the software controlling the present invention has rotated the starting point indication by 90 degrees clockwise, relative to the configuration shown in FIG. 5A. Because the starting point is rotated 90 degrees clockwise, this means that the correct pattern-based password is also rotated by 90 degrees clockwise. In FIG. 5B, the dashed line shows a user's fingertip path tracing out the correct pattern-based password, rotated 90 degrees clockwise from its default orientation shown in FIG. 5A.

FIG. 5C shows touchscreen display 550 including starting point indication 552. Note that the software controlling the present invention has rotated the starting point indication by 180 degrees about the centerpoint, relative to the configuration shown in FIG. 5A. Because the starting point is rotated 180 degrees, this means that the correct pattern-based password is also rotated by 180 degrees. In FIG. 5C, the dashed line shows a user's fingertip path tracing out the correct pattern-based password, rotated 180 degrees from its default orientation shown in FIG. 5A.

FIG. 5D shows touchscreen display 575 including starting point indication 577. Note that the software controlling the present invention has rotated the starting point indication by 90 degrees counterclockwise about the centerpoint, relative to the configuration shown in FIG. 5D. Because the starting point is rotated 90 degrees counterclockwise about the centerpoint, this means that the correct pattern-based password is also rotated by 90 degrees counterclockwise. In FIG. 5D, the dashed line shows a user's fingertip path tracing out the correct pattern-based password, rotated 90 degrees counterclockwise from its default orientation shown in FIG. 5A.

For any given password entry instance, the software chooses between the four orientations of FIGS. 5A to 5D. For example, the starting point (and associated pattern angular orientation) could be chosen randomly. As an alternative example, the four possibilities could be presented cyclically and in order for entry instance to entry instance. Regardless of exactly how the software chooses between the four starting points, the cumulative expected grease pattern is shown by the union of the four dashed lines in display 590 of FIG. 5E. This grease pattern will not allow the pattern-based password to be determined by observation of the grease pattern, thereby enhancing security.

The foregoing embodiment 500, 525, 550, 575 has only four possible angular orientations for the pattern-based password. Alternatively, the rotations could be by 45 degree increments, instead of 90 degree increments, thereby increasing the number of possible orientations to eight (8). It is noted that this increase in the number of orientation would change the shape, as well as the angular orientation, of the pattern. As a further alternative, there could be an indication, for each password entry instance, as to whether the pattern is to be entered in a clockwise manner, or a counterclockwise manner. However, it should be understood that some of these variations in the number of starting points (also called angular resolution) or in the clockwise/counterclockwise (CW/CCW) direction of the user's trace might make it more-than-optimally difficult for users to remember and/or apply their pattern-based passwords. In general, system designers should balance the need for security against ease of use when designing specific embodiments of the present invention.

Returning to FIG. 5A, the original upper-left location is indicated to the user by flashing (optionally, the indicator location could be set as a preference by the user, for example, top middle). Alternatively, the start indication could indicate the starting position by one or more of the following characteristics: highlight, color, shape, size, font, etc.

In the example of FIGS. 5A to 5E, regardless of the random rotation of the starting location, the user always draws the same pattern. The user could optionally move their device such that they are not confused and can draw the pattern from the direction that they are used to drawing it. After the use of the device a few times, the grease stains might look like the dashed lines of FIG. 5E, which makes it more difficult to guess the passcode or PIN.

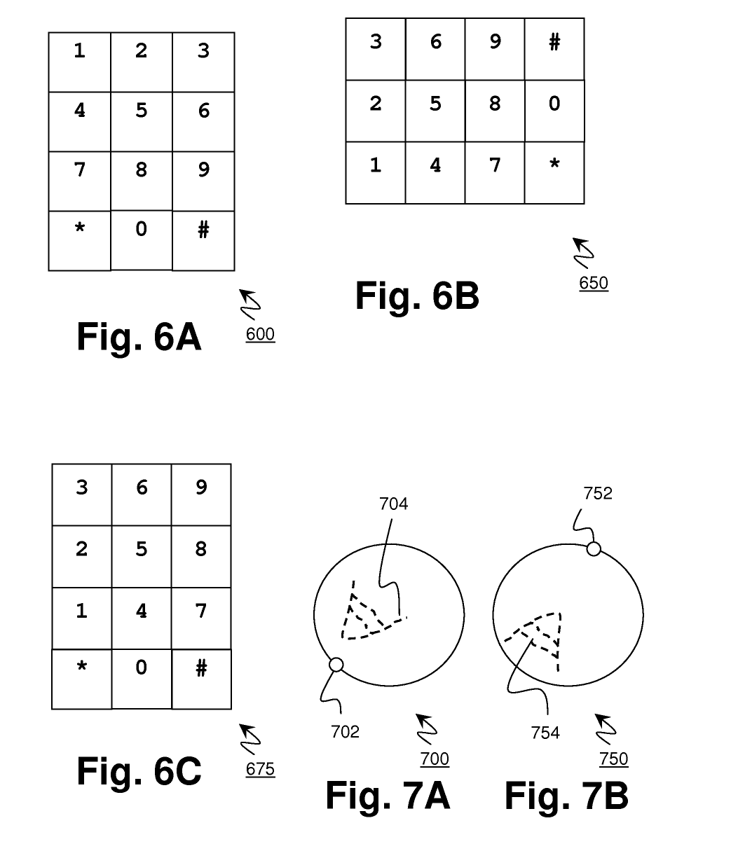

FIGS. 6A and 6B respectively show default display 600 and rotated display 650. In this example 600, 650, the system uses a touchscreen keyboard rather than a pattern input user interface. When a user is presented with the rotated display 650 (instead of the more standard layout of default display 600), then an onlooker seeking to illicitly discover the password would think the user is hitting the “1” key when the user's hand position is the upper left hand corner. However, because of the rotation of the keypad in display 650, the user would actually be hitting the “7” key, thereby thwarting the onlooker's nefarious “shoulder surfing” scheme.

FIG. 6C shows display 675 where only a portion of the keyboard has been rotated. As shown in FIG. 6C, the “*0#” row of the keyboard has not been rotated in order to: (i) avoid changing the footprint of the keypad display; and/or (ii) make data entry easier for the user.

In some embodiments of the present invention, this same concept is applied to full touchscreen keyboards (for example QWERTY keyboards and rotated QWERTY keyboards) which allow entry of alpha-numeric passwords. In some embodiments of the present invention, this same concept is applied to backlit keypads such as ATM keypads. In a physical keypad example, a mechanism could be used to physically rotate the keypad.

Some embodiments of the present invention include an indicator on a soft keyboard/pad to specify a starting point for a user to begin drawing a pattern-based password to unlock the device. In these embodiments, regardless of the random rotation of the keypad, the user always draws the same pattern.

FIG. 7A shows touchscreen security interface 700 including rotational orientation indicator 702 and correct double-bar-A finger trace 704. FIG. 7B shows touchscreen security interface 750 including rotational orientation indicator 752 and correct double-bar-A finger trace 754. In interfaces 700 and 750, the rotational orientation indicator is visible to the user and indicates to the user how to orient her finger gesture(s) (in this case a double-bar-A pattern-based password). This shows that some embodiments of the present invention do not define and/or evaluate the pattern-based password gesture(s) by its/their position relative to a matrix of elements as the embodiments of FIGS. 4, 5 and 6 do. While this embodiment of FIGS. 7A and 7B requires a multiple stroke gesture (see Definitions sub-section, below), some embodiments of the present invention are limited to one or more of the following types: (i) single gesture passwords that can be made with a single continuous motion; (ii) passwords made up of straight line strokes; and/or (iii) passwords made up of mutually orthogonal straight line strokes (see FIG. 5A, for example).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: non-exclusive or; for example, A and/or B means that: (i) A is true and B is false; or (ii) A is false and B is true; or (iii) A and B are both true.

Gesture: a motion, or set of motions, made to input data to a touchscreen; “gestures” do not include taps, hits or key strikes because these are not considered as motions.

Orientation indication: any visual indication provided in a touchscreen display designed to indicate to a user a correct angular, or rotational, orientation for entry of a pattern based password.

What is claimed is:

1. A method comprising:
selecting a selected security interface display from a plurality of possible security interface displays; and
sending the selected security interface display data for making the selected security interface display;
wherein:
each security interface display of the plurality of possible security interface displays includes a pattern entry area and an orientation indication;
each orientation indication is a visual indication of correct pattern-based password entry angular orientation;
at least two of the security interface displays of the plurality of possible security interface displays have respective orientation indications that respectively indicate different correct pattern-based password angular orientations; and
at least the sending step is performed by computer software running on computer hardware.

2. The method of claim 1 further comprising the step of:
displaying the selected security interface display on a touchscreen device.

3. The method of claim 2 further comprising the step of:
receiving pattern data corresponding to a user's entry of a pattern-based password through the selected security interface display of the touchscreen device.

4. The method of claim 3 further comprising the step of:
authenticating a user based upon the pattern data and the orientation indication of the selected security interface display.

5. The method of claim 1 wherein the pattern entry area of each security interface display takes one, or more, of the following forms: (i) an alphabetic keypad including discrete areas for different letters, (ii) a numeric keypad including discrete areas for different letters, and (iii) an orthogonal matrix of rectangular areas.

6. The method of claim 1 wherein:
each security interface display of the plurality of possible security interface displays further includes subdivision indications that visibly sub-divide the password entry area into a matrix of password entry area elements; and
the visual indication of correct password entry angular orientation is provided by visibly marking one of the password entry elements as a terminal point for entry of the correct pattern-based password.

7. A computer program product comprising software stored on a software storage device, the software comprising:
first program instructions programmed to select a selected security interface display from a plurality of possible security interface displays; and
second program instructions programmed to send the selected security interface display data for making the selected security interface display;
wherein:
each security interface display of the plurality of possible security interface displays includes a pattern entry area and an orientation indication;
each orientation indication is a visual indication of correct pattern-based password entry angular orientation;
at least two of the security interface displays of the plurality of possible security interface displays have respective orientation indications that respectively indicate different correct pattern-based password angular orientations; and
the software is stored on a software storage device in a manner less transitory than a signal in transit.

8. The product of claim 7 further comprising:
third program instructions programmed to display the selected security interface display on a touchscreen device based upon the selected security interface display data.

9. The product of claim 8 further comprising:
fourth program instructions programmed to receive pattern data corresponding to a user's entry of a pattern-based password through the selected security interface display of the touchscreen device.

10. The product of claim 9 further comprising:
fifth program instructions programmed to authenticate a user based upon the pattern data and the orientation indication of the selected security interface display.

11. The product of claim 7 wherein the pattern entry area of each security interface display takes one, or more, of the following forms: (i) an alphabetic keypad including discrete areas for different letters, (ii) a numeric keypad including discrete areas for different letters, and (iii) an orthogonal matrix of rectangular areas.

12. The product of claim 7 wherein:
each security interface display of the plurality of possible security interface displays further includes subdivision indications that visibly sub-divide the password entry area into a matrix of password entry area elements; and
the visual indication of correct password entry angular orientation is provided by visibly marking one of the password entry elements as a terminal point for entry of the correct pattern-based password.

13. A computer system comprising:
a processor(s) set; and
a software storage device;
wherein:
the processor set is structured, located, connected and/or programmed to run software stored on the software storage device;
the software comprises:
first program instructions programmed to select a selected security interface display from a plurality of possible security interface displays, and
second program instructions programmed to send the selected security interface display data for making the selected security interface display;
each security interface display of the plurality of possible security interface displays includes a pattern entry area and an orientation indication;
each orientation indication is a visual indication of correct pattern-based password entry angular orientation; and
at least two of the security interface displays of the plurality of possible security interface displays have respective orientation indications that respectively indicate different correct pattern-based password angular orientations.

14. The system of claim 13 wherein the software further comprises:
third program instructions programmed to display the selected security interface display on a touchscreen device based upon the selected security interface display data.

15. The system of claim 14 wherein the software further comprises:
fourth program instructions programmed to receive pattern data corresponding to a user's entry of a pattern-based password through the selected security interface display of the touchscreen device.

16. The system of claim 15 wherein the software further comprises:
fifth program instructions programmed to authenticate a user based upon the pattern data and the orientation indication of the selected security interface display.

17. The system of claim 13 wherein the pattern entry area of each security interface display takes one, or more, of the following forms: (i) an alphabetic keypad including discrete areas for different letters, (ii) a numeric keypad including discrete areas for different letters, and (iii) an orthogonal matrix of rectangular areas.

18. The system of claim 13 wherein:
each security interface display of the plurality of possible security interface displays further includes subdivision indications that visibly sub-divide the password entry area into a matrix of password entry area elements; and
the visual indication of correct password entry angular orientation is provided by visibly marking one of the password entry elements as a terminal point for entry of the correct pattern-based password.
